(19) United States
(12) Patent Application Publication
(10) Pub. No.: US 2026/0323610 A1
(43) Pub. Date: Oct. 15, 2026

(54) METHOD AND APPARATUS FOR TRANSMITTING CARRIER AGGREGATION CAPABILITY, AND DEVICE AND STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/111,161

(22) PCT Filed: Sep. 14, 2022
(86) PCT No.: PCT/CN2022/118812

§ 371 Date: Mar. 12, 2025

(51) Int. Cl. H04W 72/0453; H04L 5/00; H04W 72/51

(52) U.S. Cl. CPC H04W 72/0453; H04L 5/001; H04W 72/51

(57) ABSTRACT

The present disclosure is applied to the technical field of wireless communications. Provided are a method and apparatus for transmitting a carrier aggregation capability, and a device and a storage medium. The method for transmitting a carrier aggregation capability is executed by a user equipment, and comprises: sending, to a network device, a carrier aggregation capability of a user equipment in a set frequency band, wherein the carrier aggregation capability comprises indication information, the indication information is used for indicating at least one information group, and the information group comprises a first bandwidth, a first quantity and a second bandwidth, the first bandwidth being the maximum bandwidth supported by member carriers, the first quantity being the maximum number of member carriers supported on the first bandwidth, and the second bandwidth being the maximum bandwidth supported after carrier aggregation is performed in the set frequency band.

### TECHNICAL FIELD

The present disclosure relates to the field of wireless communication technology, and in particular, to a method, an apparatus, a device and a readable storage medium for transmitting carrier aggregation capability.

### BACKGROUND

When user equipment (UE) reports the carrier aggregation capability supported on a certain band to the network device, it is to report its supported bandwidth class and the bandwidth combination set (BCS) corresponding to the bandwidth class.

After the network device learns the bandwidth class and BCS reported by the UE, it can learn the number of carriers supported by the UE on the band and the bandwidth combination that can complete carrier aggregation.

In the millimeter wave band below 52.6 GHz, a single carrier can already support four bandwidths, such as 50 MHz, 100 MHz, 200 MHz, and 400 MHz. When higher frequency bands are introduced, a single carrier can support more and more bandwidths. Accordingly, the supported bandwidth combinations are also increasing, so the number of bandwidth classes and corresponding fallback (or fall back) groups will also be increasing, and more and more information is to be reported when reporting the carrier aggregation capability. So, it is necessary to consider how to better report the carrier aggregation capability.

### SUMMARY

The present disclosure provides a method, device, equipment and readable storage medium for transmitting carrier aggregation capability.

A first aspect provides a method for sending a carrier aggregation capability, which is performed by UE and includes:
sending the carrier aggregation capability of the UE within a preset frequency band to a network device, wherein the carrier aggregation capability includes indication information, the indication information is indicative of at least one information group, and the information group includes: a first bandwidth, a first quantity and a second bandwidth; wherein the first bandwidth is a maximum bandwidth supported by a component carrier, the first quantity is a maximum number of component carriers supported on the first bandwidth, and the second bandwidth is a maximum bandwidth supported after carrier aggregation is performed within the preset frequency band.

In this method, when the UE sends the carrier aggregation capability within the preset frequency band to the network device, only concise indication information is carried in the carrier aggregation capability. This concise indication information in not relevant to the fallback group and only indicates the first bandwidth, which is the maximum bandwidth supported by the component carrier, the maximum number of component carriers supported on the first bandwidth, and the maximum bandwidth supported after carrier aggregation is performed within the preset frequency band. The network device can determine the bandwidth combination of carrier aggregation within the preset frequency band based on the concise indication information. Compared with a reporting manner using tables related to fallback groups, the amount of reported information can be greatly reduced, thereby effectively improving the reporting efficiency.

In some possible embodiments, the indication information includes at least one first information, each first information corresponds to at least one information group, and the first information includes: a first identifier, a second identifier and a third identifier; where the first identifier is indicative of the first bandwidth, the second identifier is indicative of the first quantity, and the third identifier is indicative of the second bandwidth.

In some possible embodiments, in ascending or descending order of the first bandwidths supported by the UE, when the first quantities corresponding to N consecutive first bandwidths are the same and the second bandwidths corresponding to the N consecutive first bandwidths are the same, first information indicative of the third bandwidth in the indication information corresponds to N information groups; where the third bandwidth is the largest first bandwidth of the N consecutive first bandwidths, and the N information groups correspond to the N consecutive first bandwidths, N being an integer greater than 1.

In some possible embodiments, the indication information includes at least one second information, each second information corresponds to at least one information group, and the second information includes: a fourth identifier and a fifth identifier; where the fourth identifier is indicative of the first bandwidth and the first quantity, and the fifth identifier is indicative of the second bandwidth.

In some possible embodiments, in ascending or descending order of the first bandwidths supported by the UE, when the first quantities corresponding to N consecutive first bandwidths are the same and the second bandwidths corresponding thereto are the same, second information indicative of the third bandwidth in the indication information corresponds to N information groups; where the third bandwidth is the largest first bandwidth of the N consecutive first bandwidths, and the N information groups correspond to the N consecutive first bandwidths, N being an integer greater than 1.

In some possible embodiments, the first quantity corresponding to the minimum first bandwidth indicated by the indication information is equal to or less than a maximum number of component carriers that can be supported by the UE.

A second aspect provides a method for receiving carrier aggregation capability, which is performed by a network device and includes:
receiving the carrier aggregation capability within a preset frequency band sent by UE, where the carrier aggregation capability includes indication information, the indication information is indicative of at least one information group, and the information group includes: a first bandwidth, a first quantity and a second bandwidth; where the first bandwidth is a maximum bandwidth supported by a component carrier, the first quantity is a maximum number of component carriers supported on the first bandwidth, and the second bandwidth is a maximum bandwidth supported after carrier aggregation is performed within the preset frequency band;
determining, according to the indication information, the first quantity and the second bandwidth corresponding to the first bandwidth supported by the UE; and
determining, according to the first quantity and the second bandwidth corresponding to the first bandwidth supported by the UE, a bandwidth combination of carrier aggregation of the UE within the preset frequency band.

In some possible embodiments, the indication information includes at least one first information, each first information corresponds to at least one information group, and the first information includes: a first identifier, a second identifier and a third identifier; where the first identifier is indicative of the first bandwidth, the second identifier is indicative of the first quantity, and the third identifier is indicative of the second bandwidth.

In some possible embodiments, the indication information includes at least one second information, each second information corresponds to at least one information group, and the second information includes: a fourth identifier and a fifth identifier; where the fourth identifier is indicative of the first bandwidth and the first quantity, and the fifth identifier is indicative of the second bandwidth.

In some possible embodiments, determining, according to the indication information, the first quantity and the second bandwidth corresponding to the first bandwidth supported by the UE includes:
determining that at least one preset bandwidth is not indicated in the indication information, where the preset bandwidth is one of the first bandwidths supported by the UE; determining, among all of the first bandwidths indicated in the indication information, a first bandwidth greater than the preset bandwidth and with a smallest difference from the preset bandwidth; determining that the first quantity corresponding to the preset bandwidth is the same as the first quantity corresponding to the determined first bandwidth; and determining that the second bandwidth corresponding to the preset bandwidth is the same as the second bandwidth corresponding to the determined first bandwidth.

A third aspect provides an apparatus for sending a carrier aggregation capability, which is configured in UE and includes:
a transceiver module, configured to send the carrier aggregation capability of the UE within a preset frequency band to a network device, where the carrier aggregation capability includes indication information, the indication information is indicative of at least one information group, and the information group includes: a first bandwidth, a first quantity and a second bandwidth; where the first bandwidth is a maximum bandwidth supported by a component carrier, the first quantity is a maximum number of component carriers supported on the first bandwidth, and the second bandwidth is a maximum bandwidth supported after carrier aggregation is performed within the preset frequency band.

A fourth aspect provides an apparatus for receiving a carrier aggregation capability, which is configured in a network device and includes:
a transceiver module, configured to receive the carrier aggregation capability within a preset frequency band sent by UE, where the carrier aggregation capability includes indication information, the indication information is indicative of at least one information group, and the information group includes: a first bandwidth, a first quantity and a second bandwidth; wherein the first bandwidth is a maximum bandwidth supported by a component carrier, the first quantity is a maximum number of component carriers supported on the first bandwidth, and the second bandwidth is a maximum bandwidth supported after carrier aggregation is performed within the preset frequency band; and
a processing module, configured to determine, according to the indication information, the first quantity and the second bandwidth corresponding to the first bandwidth supported by the UE; and determine, according to the first quantity and the second bandwidth corresponding to the first bandwidth supported by the UE, a bandwidth combination of carrier aggregation of the UE within the preset frequency band.

A fifth aspect provides an electronic device, including a processor and a memory; where the memory is configured to store a computer program; and the processor is configured to execute the computer program to implement the first aspect or any possible design thereof.

A sixth aspect provides an electronic device, including a processor and a memory; where the memory is configured to store a computer program; and the processor is configured to execute the computer program to implement the second aspect or any possible design thereof.

A seventh aspect provides a computer-readable storage medium storing thereon instructions (or computer programs, programs) which, when being called and executed on a computer, causes the computer to implement the first aspect or any possible design thereof.

An eighth aspect provides a computer-readable storage medium storing thereon instructions (or computer programs, programs) which, when being called and executed on a computer, causes the computer to implement the second aspect or any possible design thereof.

It should be understood that the foregoing general description and the following detailed description are exemplary and explanatory only, and do not limit the present disclosure.

### BRIEF DESCRIPTION OF THE DRAWINGS

The drawings described here are used to provide a further understanding of the embodiments of the present disclosure and constitute a part of this application. The schematic implementations according to some embodiments of the present disclosure and their descriptions are used to explain the embodiments of the present disclosure and do not constitute an undue limitation of the embodiments of the present disclosure in the drawings.

The accompanying drawings, which are incorporated in and constitute a part of this specification, illustrate embodiments consistent with embodiments of the disclosure and together with the description, serve to explain principles of embodiments of the disclosure.

FIG. 1 is a schematic diagram of a wireless communication system architecture according to some embodiments of the present disclosure.

FIG. 2 is an interactive schematic diagram for transmitting carrier aggregation capability according to some embodiments of the present disclosure.

FIG. 3 is a flow chart for sending carrier aggregation capability according to some embodiments of the present disclosure.

FIG. 4 is a flow chart for receiving carrier aggregation capability according to some embodiments of the present disclosure.

FIG. 5 is a structural diagram of an apparatus for sending carrier aggregation capability according to some embodiments of the present disclosure.

FIG. 6 is a structural diagram of another apparatus for sending carrier aggregation capability according to some embodiments of the present disclosure.

FIG. 7 is a structural diagram of an apparatus for receiving carrier aggregation capability according to some embodiments of the present disclosure.

FIG. 8 is a structural diagram of another apparatus for receiving carrier aggregation capability according to some embodiments of the present disclosure.

### DETAILED DESCRIPTION

Embodiments of the present disclosure will now be further described with reference to the accompanying drawings and specific implementation modes.

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with embodiments of the present disclosure. Rather, they are merely examples of apparatus and methods consistent with aspects of the disclosure as detailed in the appended claims.

The terminology used in the embodiments of the present disclosure is for the purpose of describing particular embodiments only and is not intended to limit the embodiments of the present disclosure. As used in the embodiments of the present disclosure and the appended claims, the singular forms “a”, “an” and “the” are intended to include the plural forms as well, unless the context clearly dictates otherwise. It will also be understood that the term “and/or” as used herein refers to and includes any and all possible combinations of one or more of the associated listed items.

It should be understood that although the terms “first”, “second”, “third”, etc. may be used to describe various information in the embodiments of the present disclosure, the information should not be limited to these terms. These terms are only used to distinguish information of the same type from each other. For example, without departing from the scope of the embodiments of the present disclosure, the first information may also be called second information; and similarly, the second information may also be called first information. Depending on the context, the words “if” and “in case” as used herein may be interpreted as “when” or “upon” or “in response to determining . . . ”

Embodiments of the present disclosure are described in detail below, examples of which are illustrated in the accompanying drawings, where the same or similar reference numerals refer to the same or similar elements throughout. The embodiments described below with reference to the drawings are exemplary and intended to explain the present disclosure, but are not to be construed as limitations of the present disclosure.

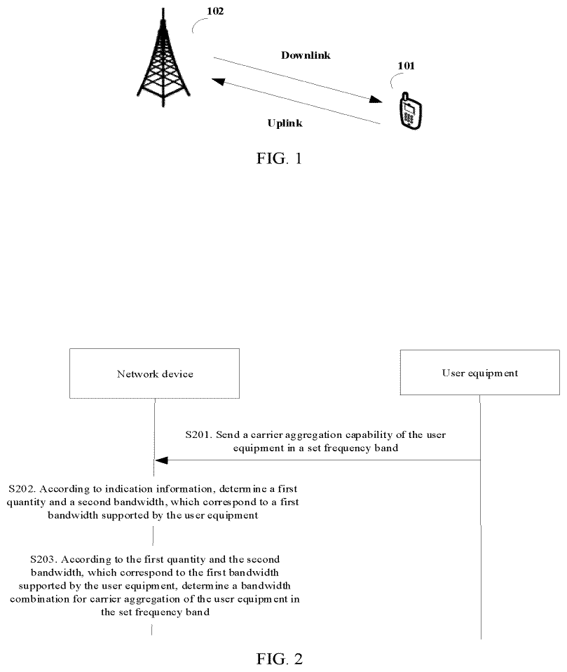

As shown in FIG. 1, a method for sending carrier aggregation capability according to some embodiments of the present disclosure can be applied to a wireless communication system 100, which may include but is not limited to a network device 101 and UE 102. The UE 102 is configured to support carrier aggregation (CA), and the UE 102 may be connected to multiple carrier units of the network device 101, including a primary carrier unit and one or more secondary carrier units.

It should be understood that the above wireless communication system 100 can be applied to both low-frequency scenarios and high-frequency scenarios. Application scenarios of the wireless communication system 100 include but are not limited to long term evolution (LTE) systems, LTE frequency division duplex (FDD) systems, LTE time division duplex (TDD) systems, worldwide interoperability for micro wave access (WiMAX) communication system, cloud radio access network (CRAN) system, future 5th-Generation (5G) system, new radio (NR) communication system or future evolved public land mobile network (PLMN) system, and the like.

The UE 102 shown above may be UE, a terminal, an access terminal, a terminal unit, a terminal station, a mobile station (MS), a remote station, a remote terminal, a mobile terminal, wireless communication equipment, terminal agent, user device, or the like. The UE 102 may have a wireless transceiver function, which can communicate (such as in wireless communication) with one or more network devices 101 in one or more communication systems, and accept network services provided by the network devices 101. Here, the network device 101 includes but not limited to the base station shown in the drawings.

Herein, the UE 102 may be a cellular phone, a cordless phone, a session initiation protocol (SIP) phone, a wireless local loop (WLL) station, a personal digital assistant (PDA) device, a handheld device or computing device with wireless communication functions; other processing devices, vehicle-mounted devices, or wearable devices connected to wireless modems; UE in future 5G networks or UE in future evolved PLMN networks, or the like.

The network device 101 may be an access network device (or access network site). Herein, the access network device refers to a device that provides network access functions, such as radio access network (RAN) base station and the like. The network device may specifically include a base station (BS) device, or include the base station device and a wireless resource management device used to control the base station device and the like. The network device may also include relay stations (relay device), access points, base stations in future 5G networks, base stations in future evolved PLMN networks, NR base stations, or the like. The network devices may be wearable devices or vehicle-mounted devices. The network device may also be a communication chip with a communication module.

For example, the network device 101 includes but is not limited to: the gNodeB (gNB) in 5G, the evolved node B (eNB) in the LTE system, the radio network controller (RNC), the Node B (NB) in the WCDMA system, the radio controller under the CRAN system, the base station controller (BSC), the base transceiver station (BTS) in the GSM system or CDMA system, th home base station (e.g., home evolved nodeB, or home node B, HNB), the baseband unit (BBU), the transmitting and receiving point (TRP), the transmitting point (TP), the mobile switching center, or the like.

Multi-carrier aggregation technology is also widely used in the 5G communication system. It is mainly divided into contiguous carrier aggregation within a frequency band, discontiguous carrier aggregation within a frequency band and carrier aggregation between frequency bands. For contiguous carrier aggregation within a frequency band, RAN4 defines the aggregate bandwidth class of contiguous carrier aggregation. In order to meet different application scenarios and different terminal capabilities, RAN4 further defines different fallback groups (FBGs).

The network device will configure a number of (e.g., 8) carriers that support CA by default for all UEs. However, some UE cannot support the aggregation of so many carriers due to limitations of its own capability. Then the UE may need to select the number of carriers that support other CAs. The number of carriers that support other CAs can be obtained based on the fallback group.

In the standard TS38.101 v17.6.0, Table 5.3A.4-1 (a part of which is shown in Table 1) shows the bandwidth class of CA and corresponding information in NR.

TABLE 1

| | | Number of contiguous | |
|---|---|---|---|
| NR CA bandwidth class | Aggregated channel bandwidth | CC | Fallback group |
| A | BW_{Channel} ≤ 400 MHz | 1 | 1, 2, 3, 4, 5 |
| B | 400 MHz < BW_{Channel}_{_{—}}_{CA} ≤ 800 MHz | 2 | 1 |
| C | 800 MHz < BW_{Channel}_{_{—}}_{CA} ≤ 1200 MHz | 3 | |
| D | 200 MHz < BW_{Channel}_{_{—}}_{CA} ≤ 400 MHz | 2 | 2 |
| E | 400 MHz < BW_{Channel}_{_{—}}_{CA} ≤ 600 MHz | 3 | |
| F | 600 MHz < BW_{Channel}_{_{—}}_{CA} ≤ 800 MHz | 4 | |
| R | 800 MHz < BW_{Channel}_{_{—}}_{CA} ≤ 1000 MHz | 5 | |
| S | 1000 MHz < BW_{Channel}_{_{—}}_{CA} ≤ 1200 MHz | 6 | |
| T | 1200 MHz < BW_{Channel}_{_{—}}_{CA} ≤ 1400 MHz | 7 | |
| U | 1400 MHz < BW_{Channel}_{_{—}}_{CA} ≤ 1600 MHz | 8 | |
| G | 100 MHz < BW_{Channel}_{_{—}}_{CA} ≤ 200 MHz | 2 | 3 |
| H | 200 MHz < BW_{Channel}_{_{—}}_{CA} ≤ 300 MHz | 3 | |
| I | 300 MHz < BW_{Channel}_{_{—}}_{CA} ≤ 400 MHz | 4 | |
| J | 400 MHz < BW_{Channel}_{_{—}}_{CA} ≤ 500 MHz | 5 | |
| K | 500 MHz < BW_{Channel}_{_{—}}_{CA} ≤ 600 MHz | 6 | |
| L | 600 MHz < BW_{Channel}_{_{—}}_{CA} ≤ 700 MHz | 7 | |
| M | 700 MHz < BW_{Channel}_{_{—}}_{CA} ≤ 800 MHz | 8 | |
| O | 100 MHz ≤ BW_{Channel}_{_{—}}_{CA} ≤ 200 MHz | 2 | 4 |
| P | 150 MHz ≤ BW_{Channel}_{_{—}}_{CA} ≤ 300 MHz | 3 | |
| Q | 200 MHz ≤ BW_{Channel}_{_{—}}_{CA} ≤ 400 MHz | 4 | |
| R2 | 200 MHz ≤ BW_{Channel}_{_{—}}_{CA} ≤ 400 MHz | 2 | 5 |
| R3 | 300 MHz ≤ BW_{Channel}_{_{—}}_{CA} ≤ 600 MHz | 3 | |
| R4 | 400 MHz ≤ BW_{Channel}_{_{—}}_{CA} ≤ 800 MHz | 4 | |
| R5 | 500 MHz ≤ BW_{Channel}_{_{—}}_{CA} ≤ 1000 MHz | 5 | |
| R6 | 600 MHz ≤ BW_{Channel}_{_{—}}_{CA} ≤ 1200 MHz | 6 | |
| R7 | 700 MHz ≤ BW_{Channel}_{_{—}}_{CA} ≤ 1400 MHz | 7 | |
| R8 | 800 MHz ≤ BW_{Channel}_{_{—}}_{CA} ≤ 1600 MHz | 8 | |
| R9 | 900 MHz ≤ BW_{Channel}_{_{—}}_{CA} ≤ 1800 MHz | 9 | |
| R10 | 1000 MHz ≤ BW_{Channel}_{_{—}}_{CA} ≤ 2000 MHz | 10 | |
| R11 | 1100 MHz ≤ BW_{Channel}_{_{—}}_{CA} ≤ 2200 MHz | 11 | |
| R12 | 1200 MHz ≤ BW_{Channel}_{_{—}}_{CA} ≤ 2400 MHz | 12 | |

Table 5.3A.4-1 define the bandwidth classes and corresponding fallback groups for millimeter wave FR2 contiguous carrier aggregation, where the bandwidth aggregation class (NR CA bandwidth class) is based on the range of total bandwidth supported after carrier aggregation. Table 1 defines some bandwidth aggregation class codes (A, B, C, D, E, F, G, H, I, J, K, L, M, O, P, Q), where the NR CA bandwidth classes correspond to the total bandwidth ranges (aggregated channel bandwidths) after carrier aggregation one by one. “Number of contiguous CC” is the number of carriers used to implement the aggregated channel bandwidth. Because the bandwidth of each carrier may be different, the same total bandwidth may correspond to different numbers of carriers. The FBGs correspond to the NR CA bandwidth classes. The definition of FBG is based on the maximum supported channel bandwidth and only one carrier bandwidth in each aggregation class is smaller than the maximum supported channel bandwidth. For example, the bandwidth aggregation class of FBG 1 is defined for the maximum channel bandwidth that a single carrier can support is 400 MHz, the bandwidth aggregation class of FBG 2 is defined for the maximum channel bandwidth that a single carrier can support is 200 MHz, and the bandwidth aggregation class of FBG 3 is defined for the maximum channel bandwidth that a single carrier can support is 100 MHz. The FBG corresponding to NR CA bandwidth class A may be FBG 1 or FBG 2 or FBG 3 or FBG 4, which is different from the FBGs corresponding to other NR CA bandwidth classes.

The aggregate bandwidth class of contiguous carrier aggregation only requires that the terminal is able to fall back to a lower-order aggregate bandwidth class in the same fallback group, and fallback between different fallback groups is not mandatory.

Table 2 below is the relevant information about the n257 frequency band in the standard TS38.101 v17.6.0.

TABLE 2

| | Uplink | | | | | | | | | Maximum | |
|---|---|---|---|---|---|---|---|---|---|---|---|
| NR CA | CA | | | | | | | | | aggre- | |
| config- | config- | BW_{Channel} | BW_{Channel} | BW_{Channel} | BW_{Channel} | BW_{Channel} | BW_{Channel} | BW_{Channel} | BW_{Channel} | gated BW | |
| uration | urations | (MHz) | (MHz) | (MHz) | (MHz) | (MHz) | (MHz) | (MHz) | (MHz) | (MHz) | BCS |
| CA_n257B | CA_n257B | 50, | 400 | | | | | | | 800 | 0 |
| | | 100, | | | | | | | | | |
| | | 200, | | | | | | | | | |
| | | 400 | | | | | | | | | |
| CA_n257C | CA_n257B | 50, | 400 | 400 | | | | | | 1200 | 0 |
| | | 100, | | | | | | | | | |
| | | 200, | | | | | | | | | |
| | | 400 | | | | | | | | | |
| CA_n257D | CA_n257D | 50, | 200 | | | | | | | 400 | 0 |
| | | 100, | | | | | | | | | |
| | | 200 | | | | | | | | | |
| CA_n257E | CA_n257D | 50, | 200 | 200 | | | | | | 600 | 0 |
| | CA_n257E | 100, | | | | | | | | | |
| | | 200 | | | | | | | | | |
| CA_n257F | CA_n257D | 50, | 200 | 200 | 200 | | | | | 800 | 0 |
| | CA_n257E | 100, | | | | | | | | | |
| | CA_n257F | 200 | | | | | | | | | |
| CA_n257G | CA_n257G | 50, | 100 | | | | | | | 200 | 0 |
| | | 100 | | | | | | | | | |
| CA_n257H | CA_n257G | 50, | 100 | 100 | | | | | | 300 | 0 |
| | CA_n257H | 100 | | | | | | | | | |
| CA_n257I | CA_n257G | 50, | 100 | 100 | 100 | | | | | 400 | 0 |
| | CA_n257H | 100 | | | | | | | | | |
| | CA_n257I | | | | | | | | | | |
| CA_n257J | CA_n257G | 50, | 100 | 100 | 100 | 100 | | | | 500 | 0 |
| | CA_n257H | 100 | | | | | | | | | |
| | CA_n257I | | | | | | | | | | |
| | CA_n257J | | | | | | | | | | |
| CA_n257K | CA_n257G | 50, | 100 | 100 | 100 | 100 | 100 | | | 600 | 0 |
| | CA_n257H | 100 | | | | | | | | | |
| | CA_n257I | | | | | | | | | | |
| | CA_n257J | | | | | | | | | | |
| | CA_n257K | | | | | | | | | | |
| CA_n257L | CA_n257G | 50, | 100 | 100 | 100 | 100 | 100 | 100 | | 700 | 0 |
| | CA_n257H | 100 | | | | | | | | | |
| | CA_n257I | | | | | | | | | | |
| | CA_n257J | | | | | | | | | | |
| | CA_n257K | | | | | | | | | | |
| | CA_n257L | | | | | | | | | | |
| CA_n257M | CA_n257G | 50, | 100 | 100 | 100 | 100 | 100 | 100 | 100 | 800 | 0 |
| | CA_n257H | 100 | | | | | | | | | |
| | CA_n257I | | | | | | | | | | |
| | CA_n257J | | | | | | | | | | |
| | CA_n257K | | | | | | | | | | |
| | CA_n257L | | | | | | | | | | |
| | CA_n257M | | | | | | | | | | |

In an example, when the UE supports 3 component carriers in the n257 frequency band, it is to report the sequence number of the BCS is O upon reporting the carrier aggregation capability and report CA_n257C (corresponding to bandwidth class C in Table 1), CA_n257E (corresponding to bandwidth class E) in Table 1, CA_n257H (corresponding to bandwidth class H in Table 1).

When higher frequency bands are introduced, a single carrier will support more and more bandwidths, and correspondingly more and more bandwidth combinations can be supported, so the number of bandwidth classes will also increase. Moreover, as the BCS value increases subsequently, when reporting the carrier aggregation capability of UE using the corresponding manner in the above table, more and more bandwidth classes may need to be reported.

In addition, the above reporting manner cannot indicate the default capability of the UE under a bandwidth class when reporting this bandwidth class. Following the previous example, when the UE supports 3 component carriers in the n257 frequency band, the reported CA_n257C corresponds to BCS including {50, 400, 400}, {100, 400, 400}, {200, 400, 400} and {400, 400, 400}. Considering the capability of the UE, based on the information that the UE supports 3 component carriers and {400, 400, 400} at the same time, it can be determined that the UE supports the BCS {200, 200, 200} in CA_n257E and the BCS {100, 100, 100} in CA_n257H. However, since bandwidth class C and bandwidth class E belong to different fallback groups in Table 1, when the UE only reports CA_n257C, the network device will not conclude, based on the UE supporting CA_n257C, that the UE can also support the BCS {200, 200, 200} in CA_n257E and the BCS {100, 100, 100} in CA_n257H. Therefore, after the UE reports that it supports CA_n257C, it may further need to report that it supports CA_n257E and report that it supports CA_n257H. This reporting manner is inefficient.

In order to improve the efficiency of reporting carrier aggregation capability, it may be considered to redefine the parameter(s) used when reporting carrier aggregation capability.

Embodiments of the present disclosure provide a method for sending carrier aggregation capability. FIG. 2 is a flow chart of a method for sending carrier aggregation capability according to an exemplary embodiment. As shown in FIG. 2, the method includes steps S201 to S203, specifically as follows.

In step S201, UE sends a carrier aggregation capability of UE in a preset frequency band to a network device.

The carrier aggregation capability includes indication information. The indication information is indicative of at least one information group, and the information group includes: a first bandwidth, a first quantity, and a second bandwidth.

Herein, the first bandwidth is the maximum bandwidth supported by a component carrier, the first quantity is the maximum number of component carriers supported on the first bandwidth, and the second bandwidth is the maximum number of component carriers supported within the preset frequency band after carrier aggregation is performed.

In some possible implementations, the preset frequency band is one frequency band. For example, the preset frequency band is n257 frequency band. For another example, the preset frequency band is n258 frequency band.

The indication information may be expressed in the following two modes.

### First Mode

The indication information includes at least one first information, each first information corresponds to at least one information group, and the first information includes: a first identifier, a second identifier and a third identifier; where the first identifier is indicative of the first bandwidth, the second identifier is indicative of the first quantity, and the third identifier is indicative of the second bandwidth.

The indication information may be in the form of complete indication. When using the complete indication mode, each first information only corresponds to one information group. If the number of single carrier bandwidths supported by the UE is M, when the complete indication mode is used, the indication information includes M pieces of first information, each piece of first information indicates an information group, and the first identifier in each piece of first information indicates a single carrier bandwidth supported by the UE. Therefore, when the complete indication mode is adopted, all single carrier bandwidths supported by the UE and their corresponding first quantities and second bandwidths can be clearly indicated.

Considering that N (the value of N is greater than 1) consecutive first bandwidths, among all first bandwidths supported by the UE, in ascending or descending order correspond to the same second quantity and correspond to the same second bandwidth, only the first information corresponding to the largest first bandwidth among the N first bandwidths is sufficient. There is no need to report the first information corresponding to the other first bandwidths among the consecutive N first bandwidths, because the other first bandwidths smaller than the largest first bandwidth among the consecutive N first bandwidths are also able to support the second quantity, and will also be smaller than the second bandwidth after carrier aggregation. Therefore, the indication information may adopt a non-complete indication mode, where the incomplete indication mode means that all the first bandwidths indicated by the first identifier in the indication information are partial bandwidths supported by the UE.

When using the incomplete indication mode, the first information of the indication information may correspond to multiple information groups. If the number of single carrier bandwidths supported by the UE is M, and the incomplete indication mode is used, the number of first information included in the indication information is less than M. When a certain first information indicates multiple information groups, the first bandwidths in the multiple information groups indicated by the first information are different, but the first quantities in the multiple information groups indicated by the first information are the same, and the second bandwidths in the multiple information groups indicated by the first information are the same. The network device can correspondingly learn which information groups correspond to the first information. Therefore, when using the incomplete indication mode, the number of bits occupied by the indication information can be saved and the uplink resources can be saved. For N consecutive first bandwidths in the ascending or descending order of all first bandwidths supported by the UE, when the first quantities corresponding thereto are the same and the second bandwidths corresponding thereto are the same, the first information, in the indication information, indicative of the third bandwidth corresponds to N information groups, and the third bandwidth is the largest first bandwidth among the N consecutive first bandwidths; the first quantity corresponding to first bandwidths, in the N information groups, other than the largest first bandwidth is the same as the first quantity corresponding to the largest first bandwidth, and the second bandwidth corresponding to first bandwidths, in the N information groups, other than the largest first bandwidth is the same as the second bandwidth corresponding to the largest first bandwidth, where N is an integer greater than 1.

When the indication information adopts the incomplete indication mode, after receiving the carrier aggregation capability reported by the UE, the network device determines that the indication information does not indicate all the first bandwidths supported by the UE, that is, determines that at least one preset bandwidth (the preset bandwidth is one of first bandwidths supported by the UE) is not indicated in the indication information. Moreover, among all the first bandwidths indicated in the indication information, the network device determines a first bandwidth that is greater than the preset bandwidth and with the smallest difference from the preset bandwidth, determines that the first quantity corresponding to the preset bandwidth is the same as the first quantity corresponding to the determined first bandwidth, and determines that the second bandwidth corresponding to the preset bandwidth is the same as the second bandwidth corresponding to the determined first bandwidth.

When the incomplete indication mode is used, the first quantity corresponding to the minimum first bandwidth indicated by the indication information is equal to the maximum number (e.g., represented as K) of component carriers that can be supported by the UE. In another example, the first quantity corresponding to the minimum first bandwidth indicated by the indication information is less than the maximum number (e.g., represented as K) of component carriers that can be supported by the UE.

Compared with the reporting manners using Table 1 and Table 2, the incomplete indication mode or the complete indication mode for the indication information can improve the reporting efficiency. The incomplete indication mode for the indication information can also save uplink resources compared with the complete indication mode.

The following is an example of the complete indication mode and the incomplete indication mode.

An example of the complete indication mode is as follows.

UE supports 5 single carrier bandwidths, including: 800 MHz, 400 MHz, 200 MHz, 100 MHz, and 50 MHz.

Detailed information of the carrier aggregation capability of UE within the preset frequency band is shown in Table 3.

TABLE 3

| | Maximum bandwidth supported by single | | | | |
|---|---|---|---|---|---|
| | component carrier | | | | |
| | 800 | 400 | 200 | 100 | 50 |
| | MHz | MHz | MHz | MHz | MHz |
| Maximum quantity | 4 | 8 | 8 | 8 | 8 |
| Maximum bandwidth | X1 | X2 | X2 | X2 | X2 |
| supported after | | | | | |
| carrier aggregation | | | | | |

Within the preset frequency band:
when the first bandwidth is 800 MHz, the first quantity is 4, and the second bandwidth is X1, the first identifier is 800, the second identifier is 4, the third identifier is X1, and the corresponding first information is {800, 4, X1};
when the first bandwidth is 400 MHz, the first quantity is 8, and the second bandwidth is X2, the first identifier is 400, the second identifier is 8, the third identifier is X2, and the corresponding first information is {400, 8, X2};
when the first bandwidth is 200 MHz, the first quantity is 8, and the second bandwidth is X2, the first identifier is 200, the second identifier is 8, the third identifier is X2, and the corresponding first information is {200, 8, X2}.
when the first bandwidth is 100 MHz, the first quantity is 8, and the second bandwidth is X2, the first identifier is 100, the second identifier is 8, the third identifier is X2, and the corresponding first information is {100, 8, X2}.
when the first bandwidth is 50 MHz, the first quantity is 8, and the second bandwidth is X2, the first identifier is 50, the second identifier is 8, the third identifier is X2, and the corresponding first information is {50, 8, X2}.

Accordingly, when the UE reports the carrier aggregation capability, if the UE supports 5 single carrier bandwidths, the indication information in the carrier aggregation capability includes 5 pieces of first information, which are: {800, 4, X1}, {400, 8, X2}, {200, 8, X2}, {100, 8, X2}, {50, 8, X2}.

An example of incomplete indication mode is as follows.

UE supports 5 single carrier bandwidths, including: 800 MHz, 400 MHz, 200 MHz, 100 MHz, and 50 MHz.

As shown in Table 3, since the corresponding first quantities are the same when the first bandwidth is 400 MHz, 200 MHz, 100 MHz, and 50 MHz, and the corresponding second bandwidths are also the same, when the UE reports the carrier aggregation capability, in case the UE supports 5 single carrier bandwidths, the indication information in the carrier aggregation capability may only include two pieces of first information, which are: {800, 4, X1}, {400, 8, X2}.

After receiving {800, 4, X1} and {400, 8, X2} reported by the UE, the network device determines that the indication information does not indicate all the first bandwidths supported by the UE, and determines that the first bandwidths not indicated in the indication information includes 200 MHz, 100 MHz, and 50 MHz. Among all the first bandwidths indicated in the indication information, the network device determines that a first bandwidth, which is greater than the first bandwidth not indicated in the indication information and has the smallest difference from the first bandwidth not indicated in the indication information, is 400 MHz. Accordingly, the network device determines that the first quantity corresponding to 200 MHz, 100 MHz, and 50 MHz is the same as the first quantity corresponding to 400 MHz, that is 8; and the corresponding second bandwidth is the same as the second bandwidth corresponding to 400 MHz, that is X2.

### Second Mode

The indication information includes at least one piece of second information, each piece of second information corresponds to at least one information group, and the second information includes: a fourth identifier and a fifth identifier; where the fourth identifier is indicative of the first bandwidth and the first quantity, and the fifth identifier is indicative of the second bandwidth corresponding to the fourth identifier.

Both the UE and the network device have learned in advance the manner in which the fourth identifier indicates the first bandwidth and the first quantity.

In an example, the fourth identifier is defined as shown in Table 4. Both UE and network device have learned the contents of Table 4 in advance.

TABLE 4

| Maximum | | | | | | | | | | |
|---|---|---|---|---|---|---|---|---|---|---|
| bandwidth | | | | | | | | | | |
| supported | | | | | | | | | | |
| by single | Maximum | | | | | | | | | |
| component | qunantiy | | | | | | | | | |
| carrier | 2 | 3 | 4 | 5 | 6 | 7 | 8 | 9 | 10 | . . . |
| 800 MHz | C2 | C3 | C4 | C5 | C6 | C7 | C8 | C9 | C10 | . . . |
| 400 MHz | D2 | D3 | D4 | D5 | D6 | D7 | D8 | D9 | D10 | . . . |
| 200 MHz | E2 | E3 | E4 | E5 | E6 | E7 | E8 | E9 | E10 | . . . |
| 100 MHz | F2 | F3 | F4 | F5 | F6 | F7 | F8 | F9 | F10 | . . . |
| 50 MHz | G2 | G3 | G4 | G5 | G6 | G7 | G8 | G9 | G10 | . . . |

In the same way as the first mode, the indication information can be in the complete indication mode or the non-complete indication mode.

The following are examples of the complete indication mode and the incomplete indication mode.

An example of the complete indication mode is as follows.

UE supports 5 single carrier bandwidths, which include: 800 MHz, 400 MHz, 200 MHz, 100 MHz, and 50 MHz.

Detailed information on the carrier aggregation capability of UE within the preset frequency band is shown in Table 3.

TABLE 3

| | Maximum bandwidth supported by single | | | | |
|---|---|---|---|---|---|
| | component carrier | | | | |
| | 800 | 400 | 200 | 100 | 50 |
| | MHz | MHz | MHz | MHz | MHz |
| Maximum quantity | 4 | 8 | 8 | 8 | 8 |
| Maximum bandwidth | X1 | X2 | X2 | X2 | X2 |
| supported after | | | | | |
| carrier aggregation | | | | | |

Within the preset frequency band:
when the first bandwidth is 800 MHz, the first quantity is 4, and the second bandwidth is X1, the fourth identifier is C4, the fifth identifier is X1, and the corresponding first information is {C4, X1};
when the first bandwidth is 400 MHz, the first quantity is 8, and the second bandwidth is X2, the fourth identifier is D8, the fifth identifier is X2, and the corresponding first information is {D8, X2};
when the first bandwidth is 200 MHz, the first quantity is 8, and the second bandwidth is X2, the fourth identifier is E8, the fifth identifier is X2, and the corresponding first information is {E8, X2};
when the first bandwidth is 100 MHz, the first quantity is 8, and the second bandwidth is X2, the fourth identifier is F8, the fifth identifier is X2, and the corresponding first information is {F8, X2};
when the first bandwidth is 50 MHz, the first quantity is 8, and the second bandwidth is X2, the fourth identifier is G8, the fifth identifier is X2, and the corresponding first information is {G8, X2}.

Accordingly, when the UE reports the carrier aggregation capability, if the UE supports 5 single carrier bandwidths, the indication information in the carrier aggregation capability includes 5 first pieces of first information, which are: {C4, X1}, {D8, X2}, {E8, X2}, {F8, X2}, {G8, X2}.

An example of incomplete indication mode is as follows.

UE supports 5 single carrier bandwidths, including: 800 MHz, 400 MHz, 200 MHz, 100 MHz, and 50 MHz.

As shown in Table 3, since the first quantities corresponding to 4 consecutive first bandwidths (i.e., 400 MHz, 200 MHz, 100 MHz, 50 MHz) in the descending order of the first bandwidths supported by the UE are the same, and the corresponding second bandwidths are also the same, then one piece of second information (i.e., the second information indicative of 800 MHz) can be indicative of 4 information groups. Accordingly, when the UE reports the carrier aggregation capability, in case the UE supports 5 single carrier bandwidths, the indication information in the carrier aggregation capability may only include two pieces of first information, which are: {C4, X1}, {D8, X2}.

After receiving the carrier aggregation capability reported by the UE, the network device determines that the indication information does not indicate all the first bandwidths supported by the UE, and determines that the first bandwidths not indicated in the indication information include 200 MHz, 100 MHz, 50 MHz. Among all the first bandwidths indicated in the indication information, the network device determines that a first bandwidth, which is greater than the first bandwidth not indicated in the indication information and has the smallest difference from the first bandwidth not indicated in the indication information, is 400 MHz. Accordingly, the network device determines that the first quantity corresponding to 200 MHz, 100 MHz, and 50 MHz is the same as the first quantity corresponding to 400 MHz, that is 8; and the corresponding second bandwidth is also the same as the second bandwidth corresponding to 400 MHz, that is X2.

Another example is given according to Table 4 and Table 5. Compared with Table 3, Table 5 supports 3 maximum bandwidths after carrier aggregation, namely X1, X2 and X3

TABLE 5

| | Maximum bandwidth | | | | |
|---|---|---|---|---|---|
| | 800 | 400 | 200 | 100 | 50 |
| | MHz | MHz | MHz | MHz | MHz |
| Maximum quantity | 4 | 8 | 10 | 10 | 10 |
| Maximum bandwidth | X1 | X2 | X3 | X3 | X3 |
| supported after | | | | | |
| carrier aggregation | | | | | |

In the complete indication mode, when the UE reports the carrier aggregation capability, the indication information in the carrier aggregation capability includes 5 pieces of first information, which specifically are: {C4, X1}, {D8, X2}, {E10, X3}, {F10, X3}, {G10, X3}.

In the incomplete indication mode, when the UE reports the carrier aggregation capability, it can only report {C4, X1}, {D8, X2}, {E10, X3}.

In step S202, the network device determines, according to the indication information, the first quantity and the second bandwidth corresponding to the first bandwidth supported by the UE.

In some possible implementations, when the network device determines that at least one preset bandwidth is not indicated in the indication information, where the preset bandwidth is a first bandwidth supported by the UE, the network device determines, from all first bandwidths indicated in the indication information, a first bandwidth that is greater than the preset bandwidth and has the smallest difference from the preset bandwidth, then determines that the first quantity corresponding to the preset bandwidth is the same as the first quantity corresponding to the determined first bandwidth, and determines that the second bandwidth corresponding to the preset bandwidth is the same as the second bandwidth corresponding to the determined first bandwidth.

For example, when the UE reports {C4, X1}, {D8, X2}, {E10, X3}, the network device determines that relevant information of 100 MHz and 50 MHz is not indicated in the indication information. Accordingly, the network device determines, from all first bandwidths indicated in the indication information, a first bandwidth that is greater than the preset bandwidth and has the smallest difference from the preset bandwidth is 200 MHz (according to Table 4, E in E10 represents 200 MHz), then determines that the first quantity corresponding to 100 MHz and 50 MHz is 10, and the corresponding second bandwidth is X3.

In step S203, the network device determines, according to the first quantity and the second bandwidth corresponding to the first bandwidth supported by the UE, a carrier aggregation bandwidth combination of the UE within the preset frequency band.

In an example, the network device receives the indication information sent by the UE as {C4, X1}. When X1=2000 MHz, it indicates that the maximum bandwidth supported by the UE after performing carrier aggregation is 2000 MHz. Then the network device determines, according to the indication information, the carrier aggregation bandwidth combination of UE within the preset frequency band as follows.

When the number of component carriers is 2, the two component carriers are represented as CC1 and CC2. If CC1+CC2≤2000 MHz is to be satisfied, the bandwidth of each component carrier can be any single carrier bandwidth supported by the UE, that is, the carrier aggregation bandwidth combination is (800, 400, 200, 100, 50)+(800, 400, 200, 100, 50).

When the number of component carriers is 3, the three component carriers are represented as CC1, CC2 and CC3. If CC1+CC2+CC3≤2000 MHz is to be satisfied, the bandwidth of one of the component carriers cannot exceed 400 MHz, that is, the carrier aggregation bandwidth combination is (800, 400, 200, 100, 50)+(800, 400, 200, 100, 50)+(400, 200, 100, 50).

When the number of component carriers is 4, the 4 component carriers are represented as CC1, CC2, CC3 and CC4. If CC1+CC2+CC3+CC4≤2000 MHz is to be satisfied, the bandwidths of two component carriers cannot exceed 200 MHz, that is the carrier aggregation bandwidth combination is (800, 400, 200, 100, 50)+(800, 400, 200, 100, 50)+(200, 100, 50)+(200, 100, 50); or the bandwidth of three component carriers cannot exceed 400 MHz, that is, the carrier aggregation bandwidth combination is (800, 400, 200, 100, 50)+(400, 200, 100, 50)+(400, 200, 100, 50)+(400, 200, 100, 50).

After determining the carrier aggregation bandwidth combination within the preset frequency band, the network device can configure any bandwidth combination according to the service demand information of the UE.

In another example, the network device receives the indication information sent by the UE as {E10, X3}. When X3=1500 MHz, it indicates that the maximum bandwidth supported by the UE after performing carrier aggregation is 1500 MHz. Then the network device determines, according to the indication information, the carrier aggregation bandwidth combination of UE within the preset frequency band as follows.

When the number of component carriers is 2, the carrier aggregation bandwidth combination is (200, 100, 50)+(200, 100, 50).

When the number of component carriers is 3, the carrier aggregation bandwidth combination is (200, 100, 50)+(200, 100, 50)+(200, 100, 50).

When the number of component carriers is 4, the carrier aggregation bandwidth combination is (200, 100, 50)+(200, 100, 50)+(200, 100, 50)+(200, 100, 50).

When the number of component carriers is 5, the carrier aggregation bandwidth combination is (200, 100, 50)+(200, 100, 50)+(200, 100, 50)+(200, 100, 50)+(200, 100, 50).

When the number of component carriers is 6, the carrier aggregation bandwidth combination is (200, 100, 50)+(200, 100, 50)+(200, 100, 50)+(200, 100, 50)+(200, 100, 50)+(200, 100, 50).

When the number of component carriers is 7, the carrier aggregation bandwidth combination is (200, 100, 50)+(200, 100, 50)+(200, 100, 50)+(200, 100, 50)+(200, 100, 50)+(200, 100, 50)+(200, 100, 50).

When the number of component carriers is 8, the carrier aggregation bandwidth combination is (200, 100, 50)+(200, 100, 50)+(200, 100, 50)+(200, 100, 50)+(200, 100, 50)+(200, 100, 50)+(200, 100, 50)+(100, 50).

When the number of component carriers is 9, the carrier aggregation bandwidth combination is (200, 100, 50)+(200, 100, 50)+(200, 100, 50)+(200, 100, 50)+(200, 100, 50)+(200, 100, 50)+(200, 100, 50)+(50)+(50), or the carrier aggregation bandwidth combination is (200, 100, 50)+(200, 100, 50)+(200, 100, 50)+(200, 100, 50)+(200, 100, 50)+(200, 100, 50)+(100, 50)+(100, 50)+(100, 50).

When the number of component carriers is 10, the carrier aggregation bandwidth combination is (200, 100, 50)+(200, 100, 50)+(200, 100, 50)+(200, 100, 50)+ (200, 100, 50)+(200, 100, 50)+(100, 50)+(100, 50)+(50)+(50).

After determining the carrier aggregation bandwidth combination within the preset frequency band, the network device can configure any bandwidth combination according to the service demand information of the UE.

Considering the capability of the UE, when the maximum bandwidth of a single carrier supported by the UE is the same (e.g., in the same row in Table 4), a carrier aggregation using a higher maximum number of component carriers can support a bandwidth combination corresponding to a carrier aggregation using a lower maximum number of component carriers. For example, when the UE reports C4, it is able to support C2 and C3. Therefore, the UE can support a bandwidth combination of 3 component carriers in which the bandwidth corresponding to each component carrier is 400 MHz (called BCS {400, 400, 400}), it can also be able to support a bandwidth combination of 3 component carriers in which the bandwidth corresponding to each component carrier is 200 MHz (called BCS {200, 200, 200}). Compared to using the reporting manner of Table 1 and Table 2, in which if the UE is to report that it supports both the BCS {400, 400, 400} and the BCS {200, 200, 200}, the UE needs to report that it supports the BCS {200, 200, 200} additionally after reporting that it supports the BCS {400, 400, 400}, the reporting efficiency can be improved.

In some embodiments of the present disclosure, when the UE sends the carrier aggregation capability within the preset frequency band to the network device, only concise indication information is carried in the carrier aggregation capability. This concise indication information in not relevant to the fallback group and only indicates the first bandwidth, which is the maximum bandwidth supported by the component carrier, the maximum number of component carriers supported on the first bandwidth, and the maximum bandwidth supported after carrier aggregation is performed within the preset frequency band. The network device can determine the bandwidth combination of carrier aggregation within the preset frequency band based on the concise indication information. Compared with a reporting manner using tables related to fallback groups, the amount of reported information can be greatly reduced, thereby effectively improving the reporting efficiency.

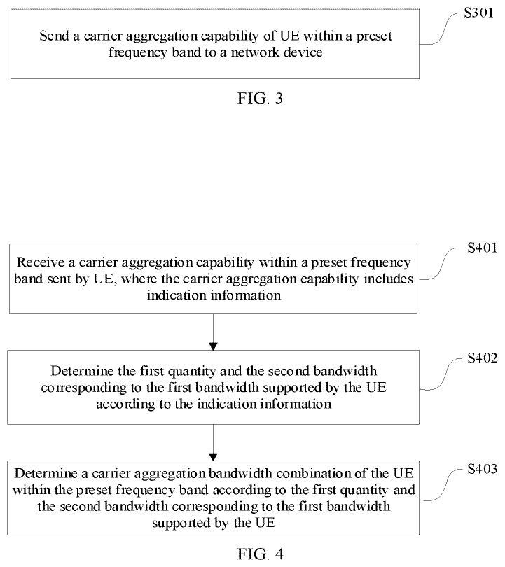

Embodiments of the present disclosure provide a method for sending carrier aggregation capability, which is performed by UE. FIG. 3 is a flow chart of a method for sending carrier aggregation capability according to an exemplary embodiment. As shown in FIG. 3, the method includes step S301, specifically as follows.

In step S301, a carrier aggregation capability of UE within a preset frequency band is sent to a network device.

The carrier aggregation capability includes indication information. The indication information is indicative of at least one information group, each first information corresponds to at least one information group, and the information group includes: a first bandwidth, a first quantity, and a second bandwidth.

Herein, the first bandwidth is the maximum bandwidth supported by the component carrier, the first quantity is the maximum number of component carriers supported on the first bandwidth, and the second bandwidth is the maximum bandwidth supported after carrier aggregation is performed within the preset frequency band.

In some possible implementations, the preset frequency band is one frequency band. For example, the preset frequency band is n257 frequency band. For another example, the preset frequency band is n258 frequency band.

The indication information may be expressed in two modes, which are described in the previous embodiments.

Embodiments of the present disclosure provide a method for receiving carrier aggregation capability, which is performed by a network device. FIG. 4 is a flow chart of a method for receiving carrier aggregation capability according to an exemplary embodiment. As shown in FIG. 4, the method includes steps S401 to S403, specifically as follows.

In step S401, a carrier aggregation capability within a preset frequency band sent by UE is received, where the carrier aggregation capability includes indication information.

The indication information is indicative of at least one information group, and the information group includes: a first bandwidth, a first quantity, and a second bandwidth. Herein, the first bandwidth is the maximum bandwidth supported by the component carrier, the first quantity is the maximum number of component carriers supported on the first bandwidth, and the second bandwidth is the maximum bandwidth supported after carrier aggregation is performed within the preset frequency band.

In step S402, the first quantity and the second bandwidth corresponding to the first bandwidth supported by the UE is determined according to the indication information.

In step S403, a carrier aggregation bandwidth combination of the UE within the preset frequency band is determined according to the first quantity and the second bandwidth corresponding to the first bandwidth supported by the UE.

Based on the same concept as the above method embodiments, embodiments of the present disclosure further provide a communication device, which can have the functions of the UE 102 in the above method embodiments, and is configured to perform the steps executed by the UE 102 according to the above embodiments. The functions can be implemented by hardware, or can be implemented by software or hardware executing corresponding software. The hardware or software includes one or more modules corresponding to the above functions.

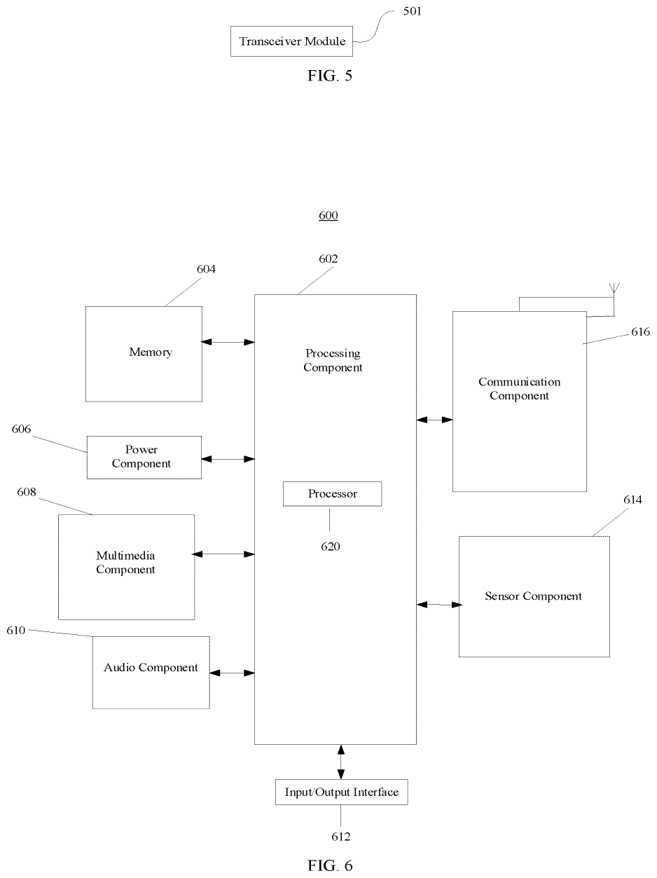

In a possible implementation, the communication device 500 shown in FIG. 5 can serve as the UE 102 involved in the above method embodiments, and perform the steps executed by the UE 102 in the above method embodiments.

The communication device 500 includes a transceiver module 501.

The transceiver module 501 is configured to configured to send a carrier aggregation capability of the UE within a preset frequency band to a network device, where the carrier aggregation capability includes indication information, the indication information is indicative of at least one information group, and the information group includes: a first bandwidth, a first quantity and a second bandwidth; where the first bandwidth is a maximum bandwidth supported by a component carrier, the first quantity is a maximum number of component carriers supported on the first bandwidth, and the second bandwidth is a maximum bandwidth supported after carrier aggregation is performed within the preset frequency band.

In some possible embodiments, the indication information includes at least one first information, each first information corresponds to at least one information group, and the first information includes: a first identifier, a second identifier and a third identifier; where the first identifier is indicative of the first bandwidth, the second identifier is indicative of the first quantity, and the third identifier is indicative of the second bandwidth.

In some possible embodiments, in ascending or descending order of the first bandwidths supported by the UE, when the first quantities corresponding to N consecutive first bandwidths are the same and the second bandwidths corresponding to the N consecutive first bandwidths are the same, first information indicative of the third bandwidth in the indication information corresponds to N information groups; where the third bandwidth is the largest first bandwidth of the N consecutive first bandwidths, and the N information groups correspond to the N consecutive first bandwidths, N being an integer greater than 1.

In some possible embodiments, the indication information includes at least one second information, each second information corresponds to at least one information group, and the second information includes: a fourth identifier and a fifth identifier; where the fourth identifier is indicative of the first bandwidth and the first quantity, and the fifth identifier is indicative of the second bandwidth.

In some possible embodiments, in ascending or descending order of the first bandwidths supported by the UE, when the first quantities corresponding to N consecutive first bandwidths are the same and the second bandwidths corresponding thereto are the same, second information indicative of the third bandwidth in the indication information corresponds to N information groups; where the third bandwidth is the largest first bandwidth of the N consecutive first bandwidths, and the N information groups correspond to the N consecutive first bandwidths, N being an integer greater than 1.

In some possible embodiments, the first quantity corresponding to the minimum first bandwidth indicated by the indication information is equal to or less than a maximum number of component carriers that can be supported by the UE.

When the communication device is UE, its structure may also be as shown in FIG. 6. FIG. 6 is a block diagram of an device 600 for sending carrier aggregation capability according to an exemplary embodiment. For example, the device 600 may be a mobile phone, a computer, a digital broadcast terminal, a messaging device, a game console, a tablet device, a medical device, a fitness device, a personal digital assistant, or the like.

Referring to FIG. 6, the device 600 may include one or more of the following components: a processing component 602, a memory 604, a power component 606, a multimedia component 608, an audio component 610, an input/output (I/O) interface 612, a sensor component 614, and a communication component 616.

Processing component 602 generally controls the overall operations of device 600, such as operations associated with display, phone calls, data communications, camera operations, and recording operations. The processing component 602 may include one or more processors 620 to execute instructions to complete all or part of the steps of the above method. Additionally, processing component 602 may include one or more modules that facilitate interaction between processing component 602 and other components. For example, processing component 602 may include a multimedia module to facilitate interaction between multimedia component 608 and processing component 602.

Memory 604 is configured to store various types of data to support operations at device 600. Examples of such data include instructions for any application or method operating on device 600, contact data, phonebook data, messages, pictures, videos, and the like. Memory 604 may be implemented by any type of volatile or non-volatile storage device, or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk.

Power component 606 provides power to various components of device 600. Power component 606 may include a power management system, one or more power supplies, and other components associated with generating, managing, and distributing power to device 600.

Multimedia component 608 includes a screen that provides an output interface between the device 600 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundaries of a touch or slide action, but also detect the duration and pressure associated with the touch or slide action. In some embodiments, multimedia component 608 includes a front camera and/or a rear camera. When the device 600 is in an operating mode, such as a shooting mode or a video mode, the front camera and/or the rear camera may receive external multimedia data. Each of the front camera and rear camera can be a fixed optical lens system or have a focal length and optical zoom capability.

Audio component 610 is configured to output and/or input audio signals. For example, audio component 610 includes a microphone (MIC) configured to receive external audio signals when device 600 is in operating modes, such as call mode, recording mode, and speech recognition mode. The received audio signals may be further stored in memory 604 or sent via communication component 616. In some embodiments, audio component 610 also includes a speaker for outputting audio signals.

I/O interface 612 provides an interface between the processing component 602 and a peripheral interface module, which may be a keyboard, a click wheel, a button, or the like. These buttons may include, but are not limited to, Home button, Volume buttons, Start button, and Lock button.

Sensor component 614 includes one or more sensors for providing various aspects of status assessment for device 600. For example, the sensor component 614 may detect the open/closed state of the device 600, the relative positioning of components, such as the display and keypad of the device 600; the sensor component 614 may also detect a change in position of the device 600 or a component of the device 600, the presence or absence of user contact with device 600, orientation or acceleration/deceleration of device 600 and temperature changes of device 600. Sensor component 614 may include a proximity sensor configured to detect the presence of nearby objects without any physical contact. Sensor component 614 may also include a light sensor, such as a CMOS or CCD image sensor, for use in imaging applications. In some embodiments, the sensor component 614 may also include an acceleration sensor, a gyroscope sensor, a magnetic sensor, a pressure sensor, or a temperature sensor.

Communication component 616 is configured to facilitate wired or wireless communication between device 600 and other devices. Device 600 may access a wireless network based on a communication standard, such as WiFi, 4G or 5G, or a combination thereof. In an exemplary embodiment, the communication component 616 receives broadcast signals or broadcast related information from an external broadcast management system via a broadcast channel. In an exemplary embodiment, the communication component 616 also includes a near field communications (NFC) module to facilitate short-range communications. For example, the NFC module can be implemented based on radio frequency identifier (RFID) technology, infrared data association (IrDA) technology, ultra-wideband (UWB) technology, Bluetooth (BT) technology and other technologies.

In an exemplary embodiment, device 600 may be implemented by one or more application specific integrated circuits (ASICs), digital signal processors (DSPs), digital signal processing devices (DSPDs), programmable logic devices (PLDs), field programmable Gate arrays (FPGAs), controllers, microcontrollers, microprocessors or other electronic components, and used for performing the above method.

Based on the same concept as the above method embodiments, embodiments of the present disclosure also provide a communication device, which can have the functions of the network device 101 in the above method embodiments, and is used to perform the steps executed by the network device 101 according to the above embodiments. The functions can be implemented by hardware, or can be implemented by software or hardware executing corresponding software. The hardware or software includes one or more modules corresponding to the above functions.

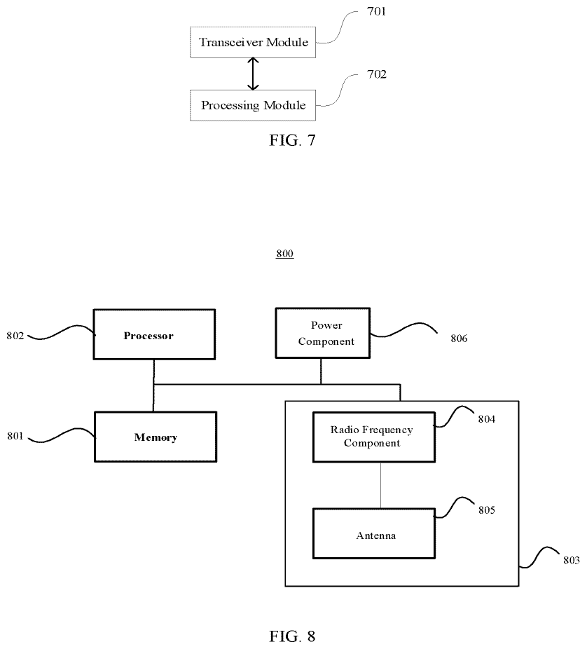

In a possible implementation, the communication device 700 shown in FIG. 7 can serve as the network device 101 involved in the above method embodiments, and perform the steps executed by the network device 101 in the above method embodiments.

The communication device 700 shown in FIG. 7 includes a transceiver module 701 and a processing module 702 for performing the steps executed by the network device 101 in the above method embodiments.

The transceiver module 701 is configured to receive the carrier aggregation capability within a preset frequency band sent by UE, where the carrier aggregation capability includes indication information, the indication information is indicative of at least one information group, and the information group includes: a first bandwidth, a first quantity and a second bandwidth; wherein the first bandwidth is a maximum bandwidth supported by a component carrier, the first quantity is a maximum number of component carriers supported on the first bandwidth, and the second bandwidth is a maximum bandwidth supported after carrier aggregation is performed within the preset frequency band.

The processing module 702 is configured to determine, according to the indication information, the first quantity and the second bandwidth corresponding to the first bandwidth supported by the UE; and determine, according to the first quantity and the second bandwidth corresponding to the first bandwidth supported by the UE, a bandwidth combination of carrier aggregation of the UE within the preset frequency band.

In some possible embodiments, the indication information includes at least one first information, each first information corresponds to at least one information group, and the first information includes: a first identifier, a second identifier and a third identifier; where the first identifier is indicative of the first bandwidth, the second identifier is indicative of the first quantity, and the third identifier is indicative of the second bandwidth.

In some possible embodiments, the indication information includes at least one second information, each second information corresponds to at least one information group, and the second information includes: a fourth identifier and a fifth identifier; where the fourth identifier is indicative of the first bandwidth and the first quantity, and the fifth identifier is indicative of the second bandwidth.

In some possible implementations, the processing module 702 is configured to determine that at least one preset bandwidth is not indicated in the indication information, where the preset bandwidth is one of the first bandwidths supported by the UE; determine, among all of the first bandwidths indicated in the indication information, a first bandwidth greater than the preset bandwidth and with a smallest difference from the preset bandwidth; determine that the first quantity corresponding to the preset bandwidth is the same as the first quantity corresponding to the determined first bandwidth; and determine that the second bandwidth corresponding to the preset bandwidth is the same as the second bandwidth corresponding to the determined first bandwidth.

When the communication device is a network device 101, its structure may also be as shown in FIG. 8. As shown in FIG. 8, the device 800 includes a memory 801, a processor 802, a transceiver component 803, and a power component 806. Herein, the memory 801 is coupled with the processor 802 and can be used to save programs and data necessary for the communication device 800 to implement various functions. The processor 802 is configured to support the communication device 800 to perform corresponding functions in the above method. The functions can be implemented by calling a program stored in the memory 801. The transceiver component 803 may be a wireless transceiver, which may be used to support the communication device 800 to receive signaling and/or data and send signaling and/or data through a wireless air interface. The transceiver component 803 may also be called a transceiver unit or a communication unit. The transceiver component 803 may include a radio frequency component 804 and one or more antennas 805. The radio frequency component 804 may be a remote radio unit (RRU), which may be used specifically for the transmission of radio frequency signals and the conversion between radio frequency signals and baseband signals. The one or more antennas 805 may be specifically used for radiating and receiving radio frequency signals.

When the communication device 800 needs to send data, the processor 802 can perform baseband processing on the data to be sent, and then output the baseband signal to the radio frequency unit. The radio frequency unit performs radio frequency processing on the baseband signal and then sends the radio frequency signal in the form of electromagnetic waves through the antenna. When data is sent to the communication device 800, the radio frequency unit receives the radio frequency signal through the antenna, converts the radio frequency signal into a baseband signal, and outputs the baseband signal to the processor 802, which then converts the baseband signal into data and processes the data.

Other implementations of the disclosed embodiments will be readily apparent to those skilled in the art, upon consideration of the specification and practice of the invention disclosed herein. This application is intended to cover any variations, uses, or adaptations of the embodiments of the disclosure that follow the general principles of the embodiments of the disclosure and include common general knowledge or conventional technical means in the art that is not disclosed in the disclosure. The specification and examples are intended to be considered as exemplary only, with a true scope and spirit of the disclosed embodiments being indicated by the following claims.

It is to be understood that the disclosed embodiments are not limited to the precise structures described above and illustrated in the accompanying drawings, and various modifications and changes may be made without departing from the scope thereof. The scope of the disclosed embodiments is limited only by the appended claims.

### INDUSTRIAL APPLICABILITY

When the UE sends the carrier aggregation capability within the preset frequency band to the network device, only concise indication information is carried in the carrier aggregation capability. This concise indication information in not relevant to the fallback group and only indicates the first bandwidth, which is the maximum bandwidth supported by the component carrier, the maximum number of component carriers supported on the first bandwidth, and the maximum bandwidth supported after carrier aggregation is performed within the preset frequency band. The network device can determine the bandwidth combination of carrier aggregation within the preset frequency band based on the concise indication information. Compared with a reporting manner using tables related to fallback groups, the amount of reported information can be greatly reduced, thereby effectively improving the reporting efficiency.

1. A method for sending a carrier aggregation capability, performed by user equipment (UE), comprising:
sending the carrier aggregation capability of the UE within a preset frequency band to a network device, wherein the carrier aggregation capability comprises indication information, the indication information is indicative of at least one information group, and the information group comprises: a first bandwidth, a first quantity and a second bandwidth; wherein the first bandwidth is a maximum bandwidth supported by a component carrier, the first quantity is a maximum number of component carriers supported on the first bandwidth, and the second bandwidth is a maximum bandwidth supported after carrier aggregation is performed within the preset frequency band.

2. The method of claim 1, wherein,
the indication information comprises at least one first information, each first information corresponds to at least one information group, and the first information comprises: a first identifier, a second identifier and a third identifier; wherein the first identifier is indicative of the first bandwidth, the second identifier is indicative of the first quantity, and the third identifier is indicative of the second bandwidth.

3. The method of claim 1 or 2, further comprising:
in ascending or descending order of the first bandwidths supported by the UE, when the first quantities corresponding to N consecutive first bandwidths are the same and the second bandwidths corresponding to the N consecutive first bandwidths are the same, first information indicative of the third bandwidth in the indication information corresponds to N information groups; wherein the third bandwidth is a largest one of the N consecutive first bandwidths, and the N information groups correspond to the N consecutive first bandwidths, where N is an integer greater than 1.

4. The method of claim 1, wherein,
the indication information comprises at least one second information, each second information corresponds to at least one information group, and the second information comprises: a fourth identifier and a fifth identifier; wherein the fourth identifier is indicative of the first bandwidth and the first quantity, and the fifth identifier is indicative of the second bandwidth.

5. The method of claim 1 or 4, wherein,
in ascending or descending order of the first bandwidths supported by the UE, when the first quantities corresponding to N consecutive first bandwidths are the same and the second bandwidths corresponding to the N consecutive first bandwidths are the same, second information indicative of the third bandwidth in the indication information corresponds to N information groups; wherein the third bandwidth is a largest one of the N consecutive first bandwidths, and the N information groups correspond to the N consecutive first bandwidths, where N is an integer greater than 1.

6. The method of any one of claims 1 to 5, wherein,
the first quantity corresponding to a minimum one of the first bandwidths indicated by the indication information is equal to or less than a maximum number of component carriers that can be supported by the UE.

7. A method for receiving a carrier aggregation capability, performed by a network device, comprising:
receiving the carrier aggregation capability within a preset frequency band sent by user equipment (UE), wherein the carrier aggregation capability comprises indication information, the indication information is indicative of at least one information group, and the information group comprises: a first bandwidth, a first quantity and a second bandwidth; wherein the first bandwidth is a maximum bandwidth supported by a component carrier, the first quantity is a maximum number of component carriers supported on the first bandwidth, and the second bandwidth is a maximum bandwidth supported after carrier aggregation is performed within the preset frequency band;
determining, according to the indication information, the first quantity and the second bandwidth corresponding to the first bandwidth supported by the UE; and
determining, according to the first quantity and the second bandwidth corresponding to the first bandwidth supported by the UE, a bandwidth combination of carrier aggregation of the UE within the preset frequency band.

8. The method of claim 7, wherein,
the indication information comprises at least one first information, each first information corresponds to at least one information group, and the first information comprises: a first identifier, a second identifier and a third identifier; wherein the first identifier is indicative of the first bandwidth, the second identifier is indicative of the first quantity, and the third identifier is indicative of the second bandwidth.

9. The method of claim 7, wherein,
the indication information comprises at least one second information, each second information corresponds to at least one information group, and the second information comprises: a fourth identifier and a fifth identifier; wherein the fourth identifier is indicative of the first bandwidth and the first quantity, and the fifth identifier is indicative of the second bandwidth.

10. The method according to any one of claims 7 to 9, wherein determining, according to the indication information, the first quantity and the second bandwidth corresponding to the first bandwidth supported by the UE comprises:
determining that at least one preset bandwidth is not indicated in the indication information, wherein the preset bandwidth is one of the first bandwidths supported by the UE; determining, among all of the first bandwidths indicated in the indication information, a first bandwidth greater than the preset bandwidth and with a smallest difference from the preset bandwidth; determining that the first quantity corresponding to the preset bandwidth is the same as the first quantity corresponding to the determined first bandwidth; and determining that the second bandwidth corresponding to the preset bandwidth is the same as the second bandwidth corresponding to the determined first bandwidth.

11. An apparatus for sending a carrier aggregation capability, configured in user equipment (UE), comprising:
a transceiver module, configured to send the carrier aggregation capability of the UE within a preset frequency band to a network device, wherein the carrier aggregation capability comprises indication information, the indication information is indicative of at least one information group, and the information group comprises: a first bandwidth, a first quantity and a second bandwidth; wherein the first bandwidth is a maximum bandwidth supported by a component carrier, the first quantity is a maximum number of component carriers supported on the first bandwidth, and the second bandwidth is a maximum bandwidth supported after carrier aggregation is performed within the preset frequency band.

12. An apparatus for receiving a carrier aggregation capability, configured in a network device, comprising:
a transceiver module, configured to receive the carrier aggregation capability within a preset frequency band sent by user equipment (UE), wherein the carrier aggregation capability comprises indication information, the indication information is indicative of at least one information group, and the information group comprises: a first bandwidth, a first quantity and a second bandwidth; wherein the first bandwidth is a maximum bandwidth supported by a component carrier, the first quantity is a maximum number of component carriers supported on the first bandwidth, and the second bandwidth is a maximum bandwidth supported after carrier aggregation is performed within the preset frequency band; and
a processing module, configured to determine, according to the indication information, the first quantity and the second bandwidth corresponding to the first bandwidth supported by the UE; and determine, according to the first quantity and the second bandwidth corresponding to the first bandwidth supported by the UE, a bandwidth combination of carrier aggregation of the UE within the preset frequency band.

13. An electronic device, comprising a processor and a memory, wherein,
the memory is configured to store a computer program; and
the processor is configured to execute the computer program to implement the method according to any one of claims 1-6.

14. An electronic device, comprising a processor and a memory, wherein,
the memory is configured to store a computer program; and
the processor is configured to execute the computer program to implement the method according to any one of claims 7-10.

15. A computer-readable storage medium storing instructions thereon, wherein, when the instructions are called and executed on a computer, the computer is caused to implement the method according to any one of claims 1-6.

16. A computer-readable storage medium storing instructions thereon, wherein, when the instructions are called and executed on a computer, the computer is caused to implement the method according to any one of claims 7-10.
